(19) United States
(12) Patent Application Publication
(10) Pub. No.: US 2015/0317733 A1
(43) Pub. Date: Nov. 5, 2015

(54) INVESTOR SOCIAL NETWORK

(71) Applicant: Marcos De almeida Chibly, Sao Paulo (BR)

(72) Inventor: Marcos De almeida Chibly, Sao Paulo (BR)

(21) Appl. No.: 14/700,547

(22) Filed: Apr. 30, 2015

Related U.S. Application Data
(60) Provisional application No. 61/986,935, filed on May 1, 2014.

(51) Int. Cl. G06Q 40/04; G06Q 20/22; G06Q 50/00

(52) U.S. Cl. CPC G06Q 40/04; G06Q 50/01; G06Q 20/223

(57) ABSTRACT

A computer based method for facilitating social network based trading on a computer comprises receiving an indication from a first interface device that a first transaction has been selected by a first user in a first security, providing transaction data defining the first transaction to a second interface device, through a social network, receiving an indication from the second interface device that a second user seeks to perform a second transaction copying at least one parameter of the first transaction in the first security, providing an option to the second user at the second interface device to pay an elective fee to the first user, and publicizing, on the social network, a fee paid for the second transaction from the second user to the first user.

### CROSS REFERENCE TO RELATED APPLICATIONS

The application claims priority to U.S. Application No. 61/986,935 filed May 1, 2014, the contents of which are incorporated by reference in their entirety.

### FIELD OF THE INVENTION

The invention relates to systems and methods for facilitating social network based trading. Specifically, the invention relates to systems and methods for incentivizing the participation of investors in an investor social network.

### BACKGROUND

Many approaches exist to trading, tracking, and analyzing transactions in financial instruments. Many such approaches are directed towards automated trading and professional investors, but some are directed towards individual investors. While individuals may be able to access information related to such approaches, approaches geared towards professionals often involve algorithmic trading strategies that are not available to individual investors.

Professional investors often rely on automated tools for transacting in accordance with modern approaches, using algorithmic trading tools. In electronic financial markets, algorithmic trading, robotic trading, or automated trading, is the use of computer programs to generate and execute trading orders. In these instances, a computer algorithm decides on many aspects of a transaction in securities, including selecting a security to transact, and time, price, and quantity of assets to transact. In many cases, decisions are made and orders are completed without human intervention.

These algorithmic trading tools are often so powerful and so fast that they crowd out individuals pursuing similar strategies that do not have access to these tools. While users may be able to gain access to raw data, they often lack the tools to act upon the raw data effectively without the assistance of a financial professional.

Financial professionals, as defined by legal regulations and licensing, have a fiduciary duty to put their clients' interests ahead of their own. Without such a fiduciary duty, investors cannot know the motivation of a financial professional. However, many individual investors may not be able to afford an investment professional, or may want to control their own investments. Such individuals are then forced to make difficult investment decisions with limited guidance and oversight. Further, if such individuals do want to control their investments, they are at a severe disadvantage, as they must compete with financial professionals without the benefit of the specialized tools that those financial professionals have access to.

Additionally, existing commission structures for financial professionals are generally flat or predetermined, such as a percentage of assets invested by the individual investor. These structures do not consider performance of the investments managed by the financial professional. In addition to a flat fee due to the financial professional regardless of performance from an investors perspective, the incentive for the financial professional to outperform other investors is limited without a performance based fee structure.

Several social network based investment platforms have appeared recently that attempt to resolve these issues in the current marketplace by allowing investors to “follow” financial professionals and, in some cases, copy their transactions. Basic configurations of such social networks for sharing investment information are well known, and are implemented, for example, at openbook.etoro.com and in US Patent Publication 2013/0060672. While these platforms begin to address the problems in the traditional marketplace, their effectiveness is limited by the ability of individual users to identify trustworthy financial professionals on social platforms.

Further, the existence of such social media platforms may liberate individual investors and students, allowing them to demonstrate their investment skills. Such investors may want to publicize their transactions so that other investors may mirror their actions. However, it is difficult to identify trustworthy and reliable investors and students within a social media platform.

Accordingly, there is a need for a trading platform that allows users to actively follow and promote financial professionals while effectively acting on recommendations of those financial professionals. Further, there is a need for a trading platform that allows non-professional investors to develop a following in parallel with investment professional, so that individual users may follow and act on their advice. There is a particular need for a social media platform that uses the mechanisms of social media to reliably promote successful investors willing to publicize their transactions while simultaneously incentivizing the publicizing of those transactions.

Further, in implementing such a system, there is a need for allowing individual users to effectively control the risk associated with individual transactions that they participate in based on the advice of investors on the trading platform.

### SUMMARY

In one embodiments, a computer based method is provided for facilitating social network based trading on a computer, and comprises receiving an indication from a first interface device that a first transaction has been selected by a first user in a first security, providing transaction data defining the first transaction to a second interface device, through a social network, the transaction data including at least one parameter of the first transaction, receiving an indication from the second interface device that a second user seeks to perform a second transaction copying at least one parameter of the first transaction in the first security, providing an option to the second user at the second interface device to pay an elective fee to the first user, and publicizing, on the social network, a fee paid for the second transaction from the second user to the first user, wherein the second user may optionally modify the fee paid to the first user after the second transaction is performed.

The first user may be categorized and may be ranked within his category based on the fee elected by the second user.

Further, the elective fee may be in addition to a minimum fee required to be paid by the second user to the first user. In some embodiments, such a minimum fee may be waived for the second transaction if the second transaction results in a loss for the second user. The minimum fee may also depend upon the specific asset or type of asset transferred in the first transaction.

In some embodiments, the first transaction comprises opening a financial position and closing a financial position and wherein the method includes receiving the indication that the second user seeks to perform the second transaction after the opening of the financial position before the closing of the financial position, and providing the option to the second user to pay an elective fee after the closing of the financial position.

In some embodiments, the second user has at least one pre-approved trading rule, and the transaction data provided to the second interface device triggers the indication that the second user seeks to perform the second transaction without any further input from the second user if the first transaction satisfies at least one pre-approved trading rule. In some embodiments, the at least one pre-approved trading rule is satisfied only if the second user has a first account containing sufficient funds to service a minimum fee.

In some embodiments, the second user has a risk threshold and the first transaction has a risk level and the second transaction only occurs if the second user's risk threshold is greater than the risk level of the first transaction.

The transaction data for the transaction may be made viewable to the second user at the second interface device, and the second user may have a user profile, and profile data in the user profile determines whether transaction data is viewable to the second user. This may be based, for example, on a risk threshold of the second user, or on the acceptance of increased risk by the second user.

In some embodiments, the risk threshold is calculated by the system based on responses to a user questionnaire. In others, it may be defined by the user, or defined based on transaction data related to the user, such as records of previous transactions.

In some embodiments, the method further comprises receiving an indication from the first interface device that the first transaction has been performed prior to providing transaction data related to the first transaction to a second interface device.

In some embodiments, the transaction may be defined by the first user using an algorithmic trading strategy. The first user may publish results of an algorithmic trading strategy through the social network, and wherein the results published do not include the transaction data. In such a scenario, the second user may be provided with an option to create a pre-approved trading rule, wherein the transaction data for the first transaction identified by the first user triggers the indication that the second user seeks to perform the second transaction without any further input from the second user. In some embodiments, the transaction data may not be made viewable to the second user.

In some embodiments, options available to the first user are defined or limited based on a category to which he belongs. For example, the first user may be permitted to identify a transaction in the first security but may not be permitted to perform a transaction in the first security.

In some embodiments, in providing transaction data related to the first transaction, no indication is provided as to whether the transaction identified has been performed or simulated.

In some embodiments, fees are paid from a stored value account, and wherein funds may be added to the stored value account by the second user, or may be awarded by a manager or sponsor of the social network. Such awards may be based on levels of activity within the social network or participation in promotions.

In some embodiments, the method further comprises directing the indication that the second user seeks to perform the second transaction to a brokerage through the social network.

Also provided are a computer system to facilitate the methods described comprising a first interface device, a second interface device and a computer configured to implement the methods for interacting via a computer network with the first and second interface devices.

### BRIEF DESCRIPTION OF THE DRAWINGS

FIG. 1 illustrates the basic components of an investor social network of the current disclosure.

FIG. 2 illustrates various interactions between different user types across an investor social network of the current disclosure.

FIG. 3 illustrates various interactions between a financial professional and an investor social network of the current disclosure.

FIG. 4 illustrates various interactions between an investor and an investor social network of the current disclosure.

FIG. 5 illustrates a bonus structure for a financial professional in an investor social network of the current disclosure.

FIG. 6 illustrates a bonus structure for an investor in an investor social network of the current disclosure.

FIG. 7 illustrates a management strategy through which an investor or a financial professional buys or sells assets.

FIG. 8 illustrates an exemplary user interface including an implementation of wall for an investor social network.

FIG. 9 shows an operation widget for a transaction

FIGS. 10a-c show a variety of widgets for use in the investor social network.

FIG. 11 illustrates the basic components of a system for hosting the investor social network of the current disclosure

### DETAILED DESCRIPTION OF THE PREFERRED EMBODIMENTS

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

In systems and methods according to the invention, a system provides an investor social network in which users are provided with social network accounts. The investor social network is a hub for exchanging information related to investments and financial news, and users access the investor social network through user interface devices, such as computers terminals or portable devices. The investor social network may then be used by investors to display information relating to investing, display investments in real time and, in some embodiments, facilitate investments through associations with brokerages. Because the social network is for investments, special precautions are taken to ensure security and privacy of investors. In some embodiments, viewing of information is limited to a privately registered or approved user group, insuring transparency between group members while maintaining adequate security.

In some embodiments, investments are facilitated through a broker network, supported by a brokerage or brokerages for executing transaction strategies shared on the network. While the investor social network is described primarily with respect to stock transactions, it will be understood that the principles of the invention may be applied to assorted asset classes, such as fixed income securities and other equity and debt securities.

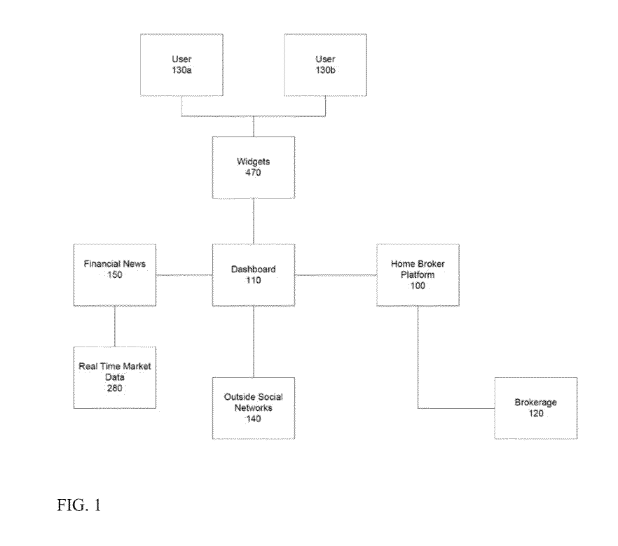

FIG. 1 illustrates the basic components of an investor social network of the current disclosure. At the core of the investor social network is a broker platform 100 and a dashboard interface 110. The broker platform 100 facilitates the interaction of the user with various brokerages and generally functions as a back end for the social media components of the platform, namely the dashboard interface 110.

The dashboard interface 110 is a hub for user interaction, and through the dashboard, users 130a-b of various types and in various categories, such as financial professionals and amateur investors, can access input from other users, outside social networks 140, and financial news 150 from a variety of sources, including RSS feeds. Financial news 150 presented on a user's dashboard interface 110 may include real time market data 280 provided through real time feeds, and it may include news provided by financial professionals within the investor social network.

Users may also use the dashboard interface 110 as an access point for the broker platform 100, and through it, users may access brokerages 120 in order to complete financial transactions that they are alerted to by other users through the dashboard interface 110.

Information presented on a user's wall may be presented in the form of widgets 470 where information is presented alongside a variable set of options customized for the type of information presented. Such widgets 470 may be the main format in which the dashboard interface 110 is presented to users, and will be discussed at more length below.

Users 130 can, in some embodiments, interact with outside social networks 140, such as Facebook, Twitter, and Google, through the dashboard interface 110. Postings on the dashboard interface 110 may be shared with other such networks, and postings from those networks may be displayed on the dashboard interface 110 if they meet certain criteria. For example, news posted to other social networks 140 may be mirrored on the dashboard interface 110 if tags are applied to the post indicating that it is related to finance, or if it is posted by users or websites known to be associated with financial news.

In the investor social network, different user types interact with the wall in different ways. Generally, in outlining interactions between users and the investor social network, it will be understood that where users interact with the dashboard interface 110, the interaction may be supported by the broker platform 100.

Where software is necessary to connect various components of the system, it is understood that such components and connection software may be provided in any form necessary to complete the relevant task. plugins may be provided, for example, to publish financial news 150, including real time market data 280, to the dashboard interface 110. These plugins may be adapted to convert standard quotation or order formats to appropriate formats for publication to and from the dashboard interface 110. Similarly, order plugins may necessarily be adapted to specific brokerage systems, and order managers may be provided to mirror transaction on the platform and at an associated brokerage. Accordingly, when a participating brokerage completes a transaction for a first user 130a, it may be reported to the dashboard interface 110, and if a second user 130b chooses to use information published on the wall to formulate a second transaction copying details of the first transaction, the second transaction may automatically be processed by the brokerage.

Through these plugins, the investor social network may provide a simplified login for a user 130, such that the network may require only a basic registration, while a link to an account with an affiliated brokerage platform 120 or investment bank may provide a more secure and robust registration.

Platform User Types and their Interactions

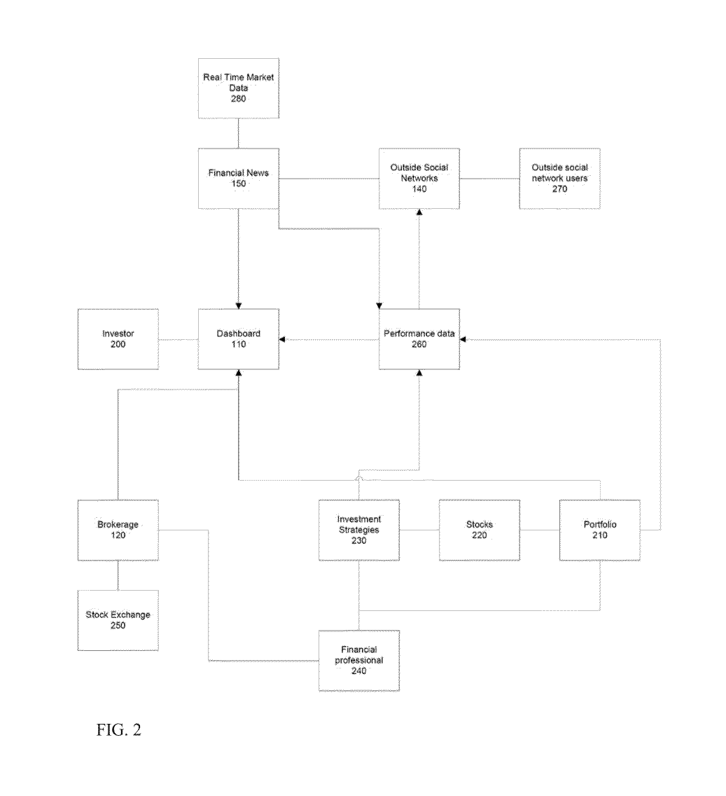

FIG. 2 illustrates various interactions between different user types across the investor social network of the current disclosure. Users 130a-b of the investor social network may be any of the described user types. The two basic user types for the platform are financial professionals 240, who are registered and authorized with any necessary bodies to have a professional role in the financial market, and other users. Typically, the other users will be investors 200. Financial professionals 240 generally have a fiduciary duty towards other investors 200, and may legally manage accounts and transact on behalf of those investors 200, as defined by local regulations.

In the figure, an investor 200 is able to access information using the dashboard interface 110. In some embodiments, for example, a brokerage 120 is accessible through the dashboard interface 110, and transactions on a stock exchange 250, for example, may be made available through the brokerage. The investors 200 interaction with the investor social network is limited, in that they can generally interact with the dashboard interface 110 through which the investor 200 can share information, chat with other users (including both investors and financial professionals 240), view information related to other users, topics, or companies that he has chosen to “follow,” and select transactions to pursue within the investor social network

“Following” a user, topic, or company, includes indicating that one is interested in receiving relevant updates, as well as advice related to potential investments. Following a user or topic may be used to define what performance data 260, investment strategy 220 and portfolio 210 information will be provided through the dashboard 110, as well which information and comments from financial professionals 240 will be presented. As will be discussed below, advice may be actionable, such that when a financial professional 240 suggests a transaction through the portfolio 210 or investment strategy 230 interface, a user may be able to execute that transaction. Through the wall, an investor 200 may follow third party investor “friends,” financial professionals 240, stock, portfolio, fund, strategy performance associated with a specific financial professional, news, recommendations, or comments related to specific assets or strategies.

A financial professional 240, on the other hand, may directly manage a portfolio 210 as well as investment strategies 230 based on stock 220 transactions. The platform may maintain performance data 260 on the investment strategy 230 and portfolio 210 of the financial professional 240, such that the performance data may be posted to the dashboard interface 110, as well as other outside social networks 140. Further, outside social network users 270 may be able to view the performance data 200 as well as financial news 150 through the outside social networks 140. Financial professionals 240 may be provided with further integration options, and may use connectors as discussed above to interface directly with brokerages 120 and report transactions directly to a user's dashboard interface 110.

Financial news 150, including real time market data 280, may be from outside sources, including RSS feeds, or it may be posted by financial professionals 240 within the platform. The financial news 150 may then be used to generate and evaluate performance data 260 for the investment strategies 230 and portfolio 210

In this way, financial professionals 240 may be able to interact directly with their investments, through defining investment strategies 230 and modifications to their portfolios 210, while investors 200 may be able to view the results of those investments at the dashboard interface 110. Financial professionals 240 may also be able to interact directly with portfolios and assets belonging to investors 200, as will be discussed further below.

The following sections will discuss, in more depth, the various interactions between the parties and the network in an investor social network.

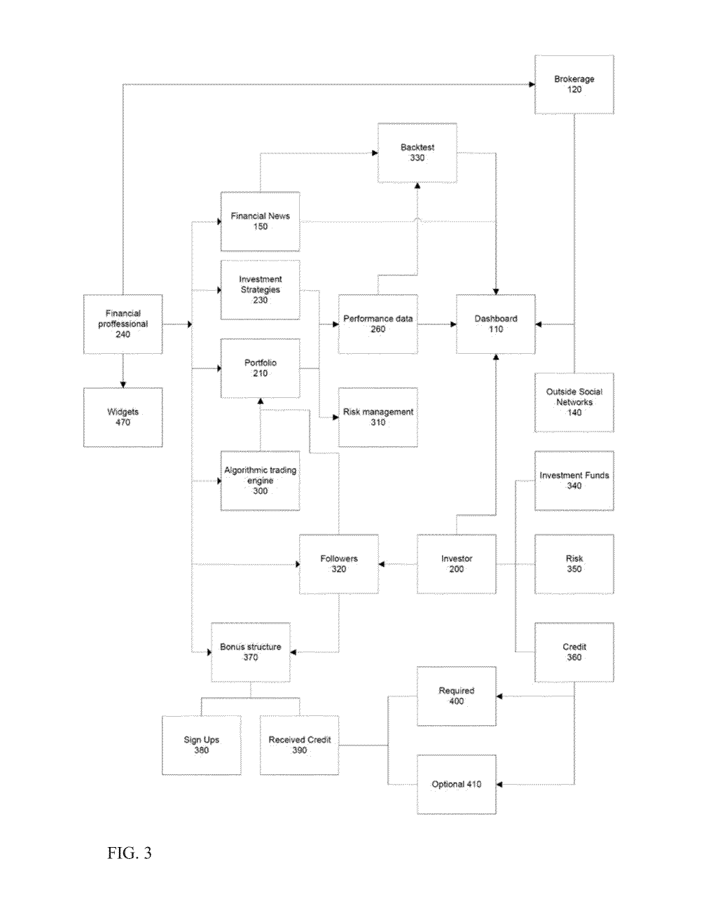

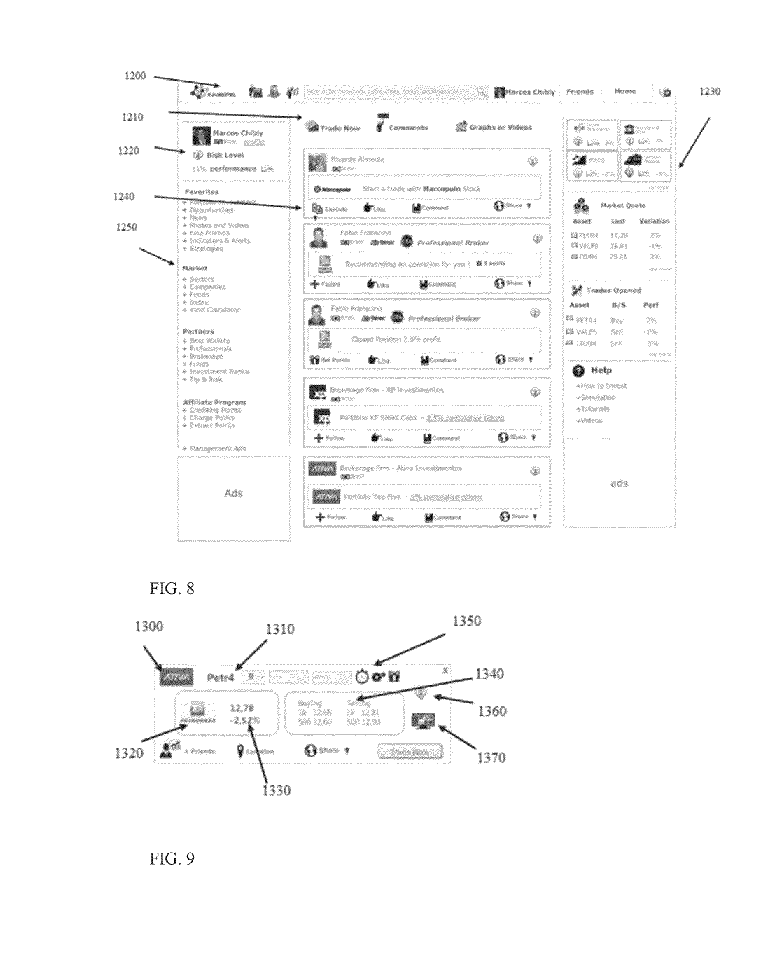

FIG. 3 illustrates various interactions between a financial professional 240 and an investor social network. A financial professional 240 may be provided with direct access to a portfolio 210 and tools for developing investment strategies 230, as discussed with respect to FIG. 2, as well as various advanced investment tools, including algorithmic trading engines 300, and other reference data in order to develop the portfolio and investment strategies. A financial professional 240 may also be given additional permissions, such as an ability to publish financial news 150 to the system, or an ability to access information about followers 320. An example of the use of the tools to develop an investment strategy 230 is described below in reference to FIG. 8.

Users 130, such as investors 200, may be able to “follow” financial professionals 240. Accordingly, some subset of investors 200 on the system may be followers of a specific financial professional 240. The financial professional 240 may be able to access information about his followers 200, such as an amount of investment funds 340 the follower has available to invest, or an amount of credit 360 that the investor 200 has to spend on fees associated with an investment within the investor social network. The financial professional 240 may, for example, be able to use the permissions to focus an investment strategy 230 on assets that are available to his followers, both in terms of funding, and in terms of an ability to pay for transactions through credit 360. The financial professional 240 may also be able to view additional information about his followers 320, such as risk profiles 350 defining the risk tolerance of an investor 200, as well as statistics about his followers generally, such that he may be able to best guide their investment strategies. In some embodiments, financial professionals 240 may be given direct control over portfolios belonging to his followers 320, such that he can make investment decisions and execute investment strategies directly for his followers. In other embodiments, followers 320 may choose to copy any investment that a specified investment strategy 230 identifies automatically. In this scenario, an investor 200 may elect to transact in a transaction identified by the strategy 230 without first being told what the transaction is. In some embodiments, investors 200 may not be told what the investment strategy 230 is. Instead, they may be able to view past results associated with the investment strategy 230, either real, or simulated using backtesting 330, and may then choose to follow the investment strategy.

It is noted that the ability to view this data and the limits of the ways in which the system and the financial professional 240 may be able to leverage this data may be dictated by local privacy and investment laws.

In addition to publishing investment strategies 230 and portfolio contents 210 directly to the dashboard interface 110, the system may also generate performance data 260 as well as risk management data 310 relate to the financial professional's 240 strategies 230 and portfolio 210 holdings. Performance data 260 may be published to the dashboard interface 110, while risk management data 310 may be maintained for other uses. The performance data 260 may be used within the platform to backtest 330 data on real-time market data 280 accessed through the financial news 150 interface. In these embodiments, an investor 200 may request that a financial professional's 240 proposed investment strategy 230 or portfolio structure 210 be backtested 330 on market data 280 from some previous period of time. The results of the backtest 330 may then be posted to the dashboard interface 110 for investors 200 to view. In some embodiments, such a backtest is run any time a new investment strategy 230 or portfolio structure 210 is proposed by a financial professional 240.

Investments accessible to investors 200 may be limited to those that fit within a risk profile 350 associated with that investor. As such, if risk management evaluations 310 illustrate that a particular financial professional 240 tends to follow high risk trading patterns, an investor 200 with a risk profile 350 defining a preference for low risk may not be provided with information associated with that financial professional 240 at the dashboard interface 110. In some embodiments, the risk management 310 evaluations are associated with individual investments, such that each investment of a financial professional 240 may be ranked as “low risk” or “high risk.” In such embodiments, a high risk investment may not be shown to an investor 200 even if the investor was following the financial professional 240. In other embodiments, an investment or financial professional 240 outside of the investors 200 risk preference may be presented to the investor 200 along with a warning, and the investor may be required to click a button to accept the higher risk level prior to participating in the specified investment.

In some embodiments, where the financial professional 240 markets himself based on results but avoids giving away details of his strategies, he may choose to publish only performance data 260 to the wall without any details of the assets being transacted. A follower 320 may then choose to follow the performance data 260, and in some scenarios request a backtest 330 based on system data. The follower may eventually choose to invest with the financial professional 240 and automatically copy that professional's transactions going forward.

In some embodiments, where the risk level as defined by the risk management 310 engine of the platform for a specific transaction is beyond the acceptable bounds defined by the risk profile 350 of an investor 200, the opportunity is not presented to the investor at all, such that the investor is never aware that the opportunity existed.

The risk level of a particular transaction may be defined by the platform automatically based on historical data associated with the asset type, transaction type, specific asset, and other factors, or it may be assigned by the financial professional 240 performing the transaction. Similarly the risk level associated with a specific financial professional 240 may be calculated based on risk management 310 evaluations within the system, or it may be defined by the professional himself. For example, a professional may indicate that investors 200 may only be his follower 320 and invest with him if they are willing to accept high risk levels.

In some embodiments, where an investor 200 is a follower 320 of a specific financial professional 240, the investor may be given access to the financial professional's algorithmic trading engine 300 and may view the portfolio 210 of the financial professional. This viewing may be through the dashboard interface 110 or through another interface associated with the investor social network, such as through an outside social network 140.

When a financial professional 240 performs a transaction within the platform through a brokerage 120, the transaction is posted to the dashboard interface 110. Investors 200 may choose to copy the transaction immediately, if they have the funds 340 and credit 360 available to perform the transaction. In some embodiments, if an investor 200 is following a financial professional 240 and has selected an appropriate option to copy transactions, the investor automatically copies the transaction and performs an identical transaction with identical parameters. In such a platform all followers who have chosen to copy transactions and are eligible to do so based on investment funds 340 available, risk 350, and system credit 360 will immediately copy a transaction. In some embodiments, the transaction of the investor may include most parameters from the original transaction, but may contain modified parameters. For example, an investor may incorporate a stop-loss parameter into an order, or may modify an existing stop-loss parameter.

A financial professional 240 may use the investor social network to monetize the distribution of financial investment advice through a bonus structure 370 associated with the platform. Bonuses may be earned in the platform through sign up referrals 380, through a large number of followers 370, or through credit received from investors 200 copying his transactions.

Credit, which may be in the form of currency or a point system within the platform, is received by an investment professional 240 when an investor 200 copies his transaction. A credit transfer may be required 400 for a follower 320 to copy an investment of the financial professional 240, and a further credit transfer may be optionally 410 provided by the investor 200 to the financial professional. Where credit is transferred through the bonus structure 370, such information is posted on the dashboard interface 110. Credits assigned by investors 200 may further be used to rank financial professionals 240 within the system.

In some embodiments, a financial professional 240 may interact with the platform through a widget 470. While a widget 470 may mirror information published to and accessible through the dashboard interface 110, it may allow for direct publication to the dashboard and direct access from the dashboard. For example, if a financial professional 240 chooses to perform a transaction through an alternate platform, they may then report the transaction to the dashboard using a widget 470, such that his followers 320 may be able to copy the transaction.

In some embodiments, the dashboard interface 110 may be made up of a series of individual widgets 470, which may take separate forms and have separate options. For example, if a user receives comments and investment opportunities, comments may appear in widgets 470 formulated for comments, which have options to “like” the comment or respond. Investment opportunities may instead appear in widgets 470 formulated to contain information relevant to those opportunities, which include an “execute” option to immediately perform the transaction. Widgets 470, either as standalone components or as the components of the wall are discussed in greater detail below.

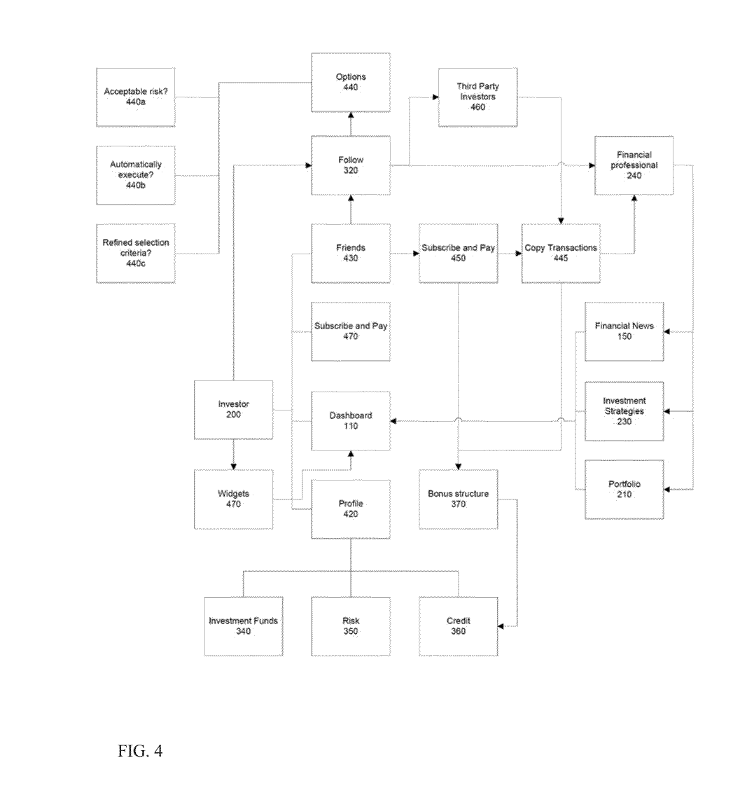

FIG. 4 illustrates various interactions between an investor 200 and an investor social network. As discussed above in reference to FIG. 2, the investor's 200 primary interaction with the investor social network is through the dashboard interface 110. However, an investor 200 may also access and modify other information within the investor social network.

Each investor may have a personal profile 420, which includes information about the user, including personal data and financial data relevant to the system, such as investment funds 340 available, acceptable risk levels 350, and credit available within the platform 360. Credit may be added to a profile by purchasing credit or through promotions by banks or third parties, as well as through a bonus structure 370, discussed at length below. Investors 200 may generate the information to populate their profiles by completing a form similar to that completed by investors when they begin using a brokerage 120. Through this form, the system may infer information and set default profile characteristics for the investor 200, such as details of the investor's 200 appetite for risk, which can be transformed into the acceptable risk level 350 in the platform. In some embodiments, the investor social network interfaces with a brokerage account 120 such that necessary information is shared across platforms, and a registration phase for the investor social network is minimal.

In following 320 a financial professional 240, an investor 200 may select several options 440, such as when the investor would like to be alerted to different opportunities presented by that financial professional. The investor 200 may opt to be alerted to all transactions or opportunities presented by that financial professional 240 regardless of risk level, or only when the risk level is within his acceptable risk level 350, 440a. The investor 200 may opt to copy 445 all transactions for which he is eligible when performed by a certain financial professional 240, 440b. Additional options 440 may be provided as well, including more refined selection criteria for copying transactions 440c. For example, an investor 200 may opt to copy transactions only when fewer than a specified amount of credit is required to be transferred.

An investor 200 may also choose to follow 320 third party investors 460, such as friends 430 discussed above. A friend 430 may be a party within the investor social network, or an outside social network user 270 currently in an alternate social network 140, which the investor 200 may follow through the dashboard interface 110. The investor social network may provide incentives for an investor 200 to convince friends 430 on other social networks 140 to join the investor social network. In some embodiments, the investor 200 may receive bonus credits 360 through the bonus structure 370 where he convinces a new user to join the network and subscribe and pay 450 for the platform, for example.

In following and being followed by third party investors 460 in the platform, an investor 200 may be provided with a different set of following options 440 than in the case of a financial professional. For example, in following a third party investor 460, an investor 200 may not allow the system to automatically perform transactions within the platform. Further, transactions presented to the investor 200 may not necessarily be executable unless they include sufficient parameters.

For example, many transactions performed within the investor social network involve opening a position in a stock at a first time and closing that position at a second time. In copying such a transaction from a financial professional 240, the investor may give an investor 200 following the professional an option to copy the transaction automatically and to close out the position to complete the transaction at a future time. The financial professional 240 may thus be given control over the investors 200 portfolio, and such a transaction may be executable or automatically copied if the transaction involves simply opening a position that the investor 200 or the financial professional 240 may then manually close at some future time. However, when copying a third party investor 460, control over the portfolio may not be given to the third party. Accordingly, the transaction may not be automatically copied, and the transaction may only be copied to the extent that full instructions for the transaction are included. Therefore, when a transaction from a third party investor 460 is transmitted to the dashboard interface 110, an investor 200 may copy 445 the transaction if it both opens a position and includes criteria for closing the position.

Examples of these distinctions will be further illustrated below in a series of scenarios. Generally, the distinction between a financial professional's 240 interactions with the platform, and those of other investors 200, 460 are that the financial professional is given the ability to control investments and view more information related to his followers. Investors 200 may be able to post information about their transactions to the dashboard interface 110, but any copying of those transactions must be manually selected by a third party investor 460 in order to be copied.

Investors 200 within the system may be traditional investors, participating in the system in order to invest funds in various securities. However, in some embodiments, investors 200 are students participating in a stock market, or other security market, simulation. This simulation may be hosted within the investor social network, or it may be an independent platform accessible through the investor social network. Students are generally provided with interactions with the platform identical to those of other investors, with several distinctions, discussed below with respect to the bonus structure 370.

### Bonus Structures

Various bonus structures 370 are provided for financial professionals 240 within the system to incentivize participation in the investor social network. Similarly, bonus structures 370 are provided for investors 200 to incentivize investments, and to incentivize the publicizing of investments. Because aspects of the bonus structure 370 are public, bonuses assigned to various participants may be used to rank users.

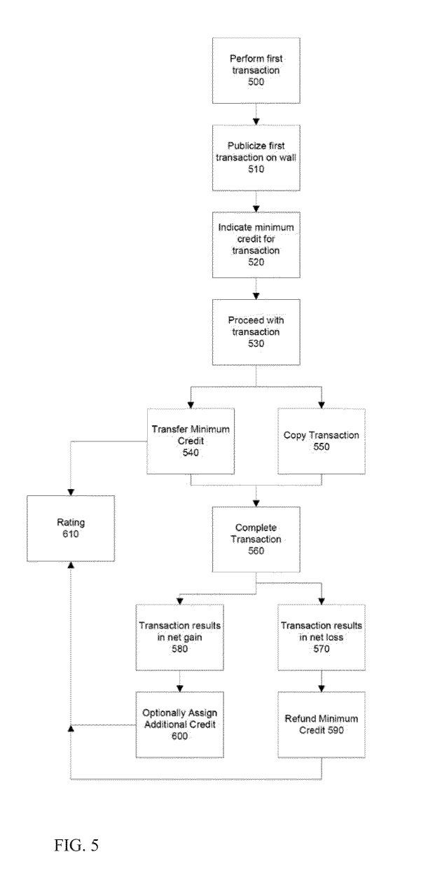

FIG. 5 illustrates a bonus structure for a financial professional 240 in an investor social network of the current disclosure. In the embodiment of FIG. 5 a financial professional 240 performs a first transaction in a security 500. This transaction is either performed or tracked at a computer interface and may be performed through an algorithmic trading engine 300, direct interaction with a portfolio 210, or an execution of an investment strategy 230. Accordingly, the transaction may be completed on at the computer interface of the broker platform 100 or it may, alternatively, be completed directly through a brokerage 120 and reported through the broker platform 100. In some embodiments, the financial professional 240 may select a transaction to perform, instead of actually performing a transaction at 500. In such an embodiment, the transaction may be fully defined, such that complete transaction information may be made available, but the transaction may have only been selected by the financial professional but not actually executed.

Accordingly, in some embodiments, the transaction performed at 500 is the execution of an investment strategy 230, such as that discussed below in reference to FIG. 8. In such an embodiment, the investor may not actually invest in an asset, but may recommend that followers 320 do so.

Because the transaction may be completed in any of a number of ways using any number of trading platforms, the transactions may have several sophisticated parameters associated with it. For example, the transaction may have algorithmic parameters tied to a variety of well known financial indicators, which can include Relative Strength Index (RSI), Moving Average Convergence divergence (MACD), Average Directional Index (ADX), Commodity Channel Index (CCI), Average True Range (ATR), high/lows, price Rate of Change (ROC) or various pivot points for financial assets, and moving averages for a financial marketplace among other potential indicators. Alternatively or in addition to such indicators, the transaction may have built in alert indicators, such as set prices or a set level for one of the financial indicators just listed. The alert indicator built into the transaction may be a set point for opening or closing a position. For example, the transaction parameters may indicate that the investor wishes to open a position when a specified financial indicator reaches a certain level and close the position when the indicator reaches a second level.

In some embodiments, the transaction performed at step 500 may be the opening of a position, with an understanding that the position will be closed at some future time.

After the first transaction is performed 500, the financial professional may publicize the transaction on the dashboard at 510. This involves posting news of the transaction, along with relevant details, on the dashboard interface 110 of the broker platform 100 where it may be viewed by various investors 200 using the platform. The investors who are able to view the details of the transaction may be followers 320 of the financial professional 240—that is, they may have chosen to follow the financial professional's transactions at some point in the past. Alternatively, the broker platform 100 may determine based on internal algorithms that the transaction is relevant to the investor 200 based on, for example, risk levels 310 and/or projected performance data 260.

In some embodiments, followers 320 of the financial professional 240 may automatically copy 445 any transaction for which they are eligible. Eligibility may include an evaluation of risk levels 350 or appropriate funding 340 and credit levels 360 within the platform. The copying 445 of the transaction may be prior to, or in place of, the publicizing of the transaction, where followers 320 have elected to automatically copy the transaction.

In some embodiments, the investor social network provides transaction data defining the first transaction to the second user through the investor social network, and the data includes parameters of the first transaction that can be used to copy the first transaction. This data may be provided to a follower 320 through the dashboard so that the follower can decide whether to copy the transaction.

In publicizing the just performed first transaction 500, on a wall 510, the transaction is presented to other users of the broker platform 100 with an option to copy 550 the transaction just completed and with an indication of a minimum amount of credit 360 needed for the transaction 520. The minimum credit 360 is the minimum price to the investor, beyond the value of the investment, of copying 550 the transaction just completed. The minimum price to the investor may be defined by the investor social network, based on an asset or asset type being transacted, or by the financial professional 240, based on his own projected value of the transaction. Accordingly, where a financial professional 240 projects a transaction to be high yield, he may require a larger credit transfer for a follower 320 to copy the transaction.

After indicating the minimum credit required 520, the investor social network may receive an indication from an investor 200 presented with the first transaction that the investor 200 would like to copy parameters of the transaction.

Copying 550 a transaction means copying of one or several parameters of the transaction, such as purchasing an identical asset or setting identical alert indicators such that an investor 200 copying the financial professional 240 will purchase an identical asset or set of assets when the financial professional opens a position. Generally, when copying 550 a transaction, the transaction will include rules for when to open and close a position.

Alternatively, an investor 200 may remain tied to the financial professional 240 through the investor social network such that he will close his position when the financial professional 240 does. In this scenario, control of the investor's 200 portfolio may be handed over to the financial professional 240. Rather than copying 550 rules for closing a position, the financial professional 240 may then be able to directly close relevant positions for all followers.

When an individual investor 200 decides to proceed with copying a transaction 530, the investor will transfer the minimum amount of credit 360 to the financial professional 240 at 540 as a fee and begin copying the transaction 550.

At a future point, a first transaction performed at 500 will be completed 560, closing any open positions. This may be by copying the closing of a parallel position of a financial professional 240, or it may be based on rules associated with the original transaction.

On the completion of the transaction 560, the transaction as a whole may be evaluated by the investor 200. On evaluating the transaction, the investor 200 may be satisfied with the financial professional 240, and may wish to assign additional credit to indicate satisfaction. For example, the transaction may result in a net gain 580, and based on that gain, the investor 200 may choose to assign additional credit 600 to the financial professional 240. However, if a transaction was merely satisfactory, the investor 200 may choose to pay only the minimum amount of credit 360 to the financial professional 240 (which had been transferred earlier at 540). To facilitate the transfer of additional credit to the financial professional 240, the investor 200 may be provided with an option to pay an elective fee to the financial professional 240.

In some embodiments, certain criteria may allow for the refunding of credits to the investor 200. For example, if the transaction resulted in a net loss 570, the system may refund the minimum credit previously transferred to the investor 200, 590. The system may refund the minimum credit automatically, or in the alternative, the system may provide an option to the investor 200 to accept a refund of the credits. The transfer of credits 360 in the broker platform 100 therefore acts as a performance based bonus system.

At each stage of the process, the financial professional 240 may be assigned a rating 610 within the investor social network based on the amount of credit 360 that have been transferred to him. For example, when the investor 200 chooses to copy 550 his transaction, the system will publicize the fact that credits 360 have been transferred to the financial professional 240. When the transaction is completed, if the investor 200 chooses to transfer additional credits to the financial professional 240, that action will be publicized through the dashboard interface 110, and if the transaction results in a loss, any refund of credits 360 may be publicized as well. Accordingly, the broker platform 100 publicizes the performance based bonuses received by financial professionals.

In some embodiments, financial professionals 240 are ranked within the investor social network based on their credit totals, or based on some statistical analysis of their credit totals. For example, an investor 200 may view financial professionals 240 ranked according to total amount of credit 360, or average number of credits per transaction. More sophisticated statistics may be provided as well, such as the average amount of credit beyond the minimum credits per transaction.

An example of this process will now be presented. John is a financial professional 240 who is licensed and is authorized to act in the broker platform 100. John uses the platform to operate an investment portfolio 210 that is followed by many investors 200, each of whom have opted to automatically copy 550 any transactions performed by John. When John invests in a security, he is effectively rated within the investor social network by other investors who either copy 550 the transaction (automatically assigning credits) or choose not to copy the transaction. If many users copy the transaction, they will each rate the transaction upon completion, or closing of the position opened by the first transaction, by deciding whether to transfer bonus credits to John.

In one scenario, John purchases stock in company A. The stock has a minimum value of two credits. This transaction is then publicized to all of John's followers who have two credits available, a total of five investors, each of whom automatically executes the transaction.

After some time passes, John closes his position at a 3% profit and each of the five investors close their parallel positions. The investors then decide to transfer a total number of credits to John as follows:

Investor 1: 3 credits

Investor 2: 4 credits

Investor 3: 5 credits

Investor 4: 10 credits

Investor 5: 2 credits

John receives a total of 24 credits. As can be seen in the credit totals awarded, investor 5 has chosen to transfer only the minimum two credits, while investor 4 has chosen to transfer 8 credits beyond the minimum 2 required for the transaction.

John then performs a second transaction in which he purchases stock in company B. The stock has a minimum value of 3 credits, and the transaction is also automatically copied by five investors. John then closes the position with a loss of 2%. The five investors, each of whom had previously assigned 3 credits to John, now close the position with a loss. In this scenario, the investors will have the option to retract the 3 credits assigned to John, as the minimum number of credits will not apply when a transaction is completed at a loss. Investors may also view the investment advice received positively despite the loss, and may transfer additional credits to John.

Over time, John will build up credit totals through successful and popular transactions, these credit assignments will function as a rating and a bonus, allowing John to gain additional followers, who may, in turn, assign additional credits to John. Such a bonus structure is both rewarding to the successful professional and informative to the individual investor.

John can later assign credits to other parties as payments or prizes, such as for a reward to loyal followers, or can convert credits to other forms of payments, such as local currency.

Further, John may attempt a high risk transaction, in which case, only investors tolerant of risk may be presented with, or may automatically copy, the transaction.

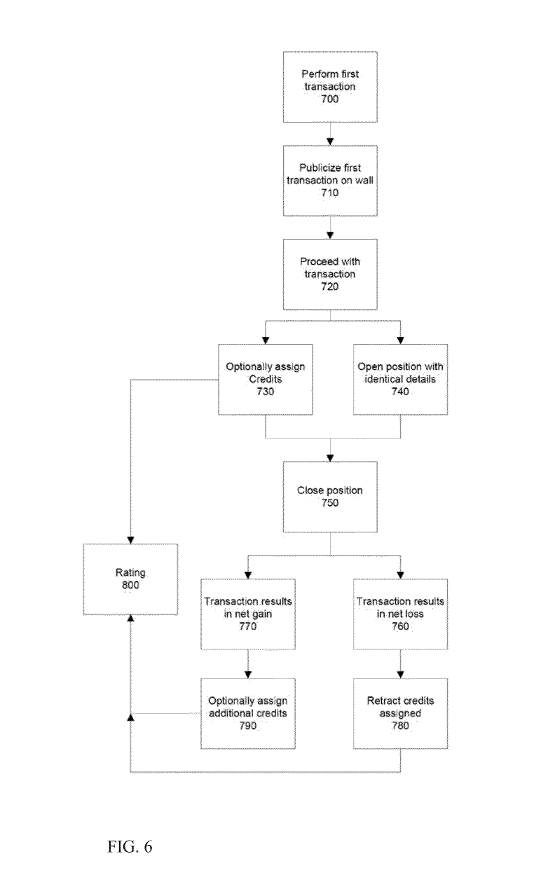

FIG. 6 illustrates a bonus structure for an investor 200 in an investor social network of the current disclosure. In the embodiment of FIG. 6 an investor 200 performs a first transaction in a security 700. This transaction is either performed or tracked at a computer interface and may be completed at the computer interface of the broker platform 100 and reported through the broker platform 100.

After the first transaction is performed 700, the investor 200 may publicize the transaction on his wall 710. This involves posting news of the transaction, along with relevant details necessary to duplicate the transaction, on the dashboard interface 110 of the broker platform 100 where it may be viewed by various third party investors 460 using the platform. The third party investors 460 who are able to view the details of the transaction may be friends 430 of the investor 200—that is, they may have chosen to follow the investors profile or transactions at some point in the past. Alternatively, the broker platform 100 may determine based on internal algorithms that the transaction is relevant to the third party investor 460 based on, for example, risk levels 310 or projected performance data 260.

As is discussed above in reference to FIG. 5, in some embodiments, the investor 200 may select an investment without actually performing the transaction. For example, investor 200 may be a student selecting transactions within the marketplace, but not actually transacting, or transacting only within a stock market simulation. In such an embodiment, the method may be identical, and the transaction may be publicized in the same manner as if the student were any other investor 200 transacting in the marketplace.

In publicizing the just performed first transaction 700, on a wall 710, the transaction is presented to other users of the broker platform 100 with an option to copy the transaction just completed by opening a position with identical details 740 to that just opened by the investor 200. While professional investors 240 may require a minimum number of credits 360 be applied in order to copy a transaction, no minimum assignment of credits is applied to a third party investor's 460 copying of an investor 200.

When copying a transaction from an investor, the details of the underlying transaction are copied. Contrary to the discussion in reference to FIG. 5, above, an investor 200 who is not a financial professional 240 may not be given control over a third party investor's 460 portfolio. Accordingly, the investor 200 cannot close a position for a friend 430. Instead, when an investor 200 proceeds with a transaction 720, they open a position with details identical to those of the first investor 740. When the time comes to close the position 750, the first investor and second investor close their positions simultaneously not because the first investor 200 controls both portfolios, as in the case of the financial professional 240, but because both positions were scheduled to be closed based on identical criteria.

While assigning credits is not mandatory upon the opening of a position, a second investor may optionally assign credits 730 to the first investor. Similarly, upon the closing of a position, the transaction as a whole may be evaluated by the third party investor 460. On evaluating the transaction, the investor 200 may be satisfied with the first investor 200, and may wish to assign credits to indicate satisfaction with the transaction. For example, the transaction may result in a net gain 770, and based on that gain, the investor may choose to assign credits to the first investor 790. However, if a transaction was merely satisfactory, the investor may choose not to assign any credits. If the second investor is dissatisfied with the total transaction, such as if the transaction resulted in a net loss 760, the investor may decide to retract credits 780 previously assigned at 730.

At each stage of the process, the investor 200 may be assigned a rating within the investor social network based on the number of credits 360 that have been transferred to him. For example, when the third party investor 460 chooses to open a position with details identical to his transaction 740, the system will publicize the fact that the transaction has been copied, and/or that credits have been transferred to the investor 200. When the transaction is completed, if the third party investor 460 chooses to transfer additional credits to the first investor 200, that action will be publicized through the dashboard interface 110, and if the transaction results in a loss, any refund of credits may be publicized as well. Accordingly, the broker platform 100 may use the credits assigned to rate amateur investors transacting within the system. Investors 200 leveraging the platform cannot force payment of fees.

### Implementing a Strategy

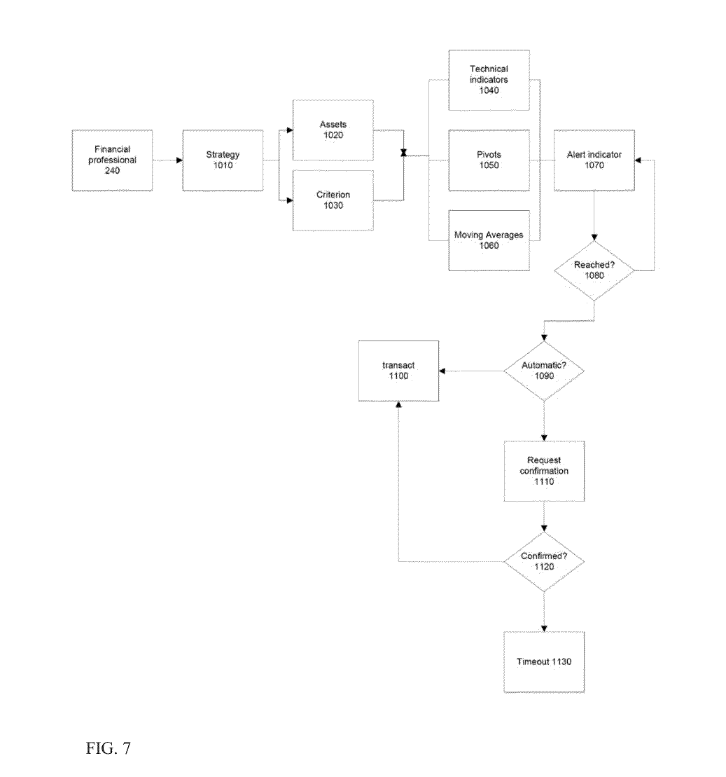

FIG. 7 illustrates a management strategy through which an investor 200 or a financial professional 240 may buy or sell assets. The illustrated method is managed by a system that will run orders for specified scenarios.

In the case of a financial professional 240, the strategy can be published to the dashboard interface 110 in a limited manner, for the purpose of marketing, where the investor 200 can monitor outcome of the investment strategy 230 without knowing the assets or strategies involved. An investor 200 may, based on prior results and a rating of the financial professional 240, choose to implement the strategy by copying all transactions selected by the strategy.

In the figure, a strategy is provided as performed by a financial professional 240. A similar strategy implementation could be performed by other investors, but with certain options limited, as discussed above. Generally, a strategy is not implemented at the dashboard interface 110, but rather, it may be implemented on the broker platform 100 or an affiliated brokerage 120.

The strategy 1010 to be implemented may be based on selecting a group of assets 1020 or a set of criterion 1030 through which assets may be selected. The assets 1020 may be any number of assets, including equities, derivatives, commodities, funds, bonds, and others. The strategy may be based on any criterion for which an algorithm can be defined, such as moving averages 1060, technical indicators 1040, or pivots 1050. A strategy may contain multiple assets with different transaction criteria.

Generally, a financial professional 240 or other investor 200 implements a strategy which may then be mirrored by his followers 320. However, in some embodiments, the strategy may be implemented without actual investment, so that the strategy runs and followers 320 who have opted to invest automatically implement the strategy.

Moving Averages 1060 may be a subcategory of technical indicators 1040, and are generally average of the values based on defined periods. Other technical indicators 1040 that may be use include RSI, Stochastic formulas, MACD, ADX, CCI, ATR, High/Lows, ROC, and others. Pivots 1050 are the support points of the price, traditionally used in developing financial strategies, such as Classic Pivot, Fibonacci, Camarilla, and others.

When some internal process alerts 1070 the system that a criteria has been reached, the system first confirms that the criteria has actually been reached 1080, and then determines if the transaction to be completed is automatic or only upon user confirmation 1090. If the implementation is automatic, all followers who have selected for automatic investment immediately perform the transaction 1100. This may include the financial professional 240, or it may include only his followers 320, or both.

If investors have opted to confirm each transaction, the system requests confirmation 1110 and then transacts 1100 upon such confirmation 1120. If no confirmation is provided, the system times out 1130.

### Evaluating Risk

In evaluating the risk tolerance 350 of a particular investor 200, various factors are taken into account. Generally, risk for a particular transaction is evaluated by comparing an expected upside with a potential downside. In the example of the strategy implementation, a professional investor 240 may define a level of risk of the strategy, or the system may define the risk level automatically. An investor's risk tolerance 350 may be compared to an investments potential risk, and if the risk level of the investment is beyond the acceptable risk level of the investor's 200 profile, the investment opportunity may not be presented to the investor.

The investor's 200 risk tolerance may be defined in his profile in several ways. He may be defined as part of an investor group or as an individual investor. Risk is then evaluated based on:

capital allocated to a particular investment or investment strategy,

objectives for investment,

asset classes and sectors in which he wishes to invest,

volatility that the investor is willing to accept in investments,

expected upside for an investment, and

time thresholds for investments, among other potential factors.

As discussed above, this information may be collected when an investor 200 opens an account on the investor social network, and completes a questionnaire. Based on answers, the system may evaluate the investors acceptable risk level.

In some embodiments, the defined risk level is defined in terms of simplified levels, such as low, medium, or high risk or colors, such as green, yellow, or red.

As an example of this calculation, a user may enter the platform for the first time, register, and answer a set of risk and investment profile questions. These questions determine:

What type of product, service, or operations are in line with the user's investment objectives, including volatility, timeframe, and expected return.

What types of such products the user's financial situation is compatible with.

To what extent the user understands the risks associated with certain types of products.

The questionnaire will provide the user with a score from 1-10. If the user's score is from 0-4, he will be rated as conservative, or low risk. If his score is from 4.1-7, he will be rated as moderate, or medium risk. If his score is above 7.1, he will be rated as aggressive, or high risk.

In some embodiments, the risk will be assessed in terms of a specific asset and a user's tolerance for volatility. For example, the maximum volatility of an asset may be weighed against an expected payback period. In other words, if the investor 200 has income expectations for one year, a year's worth of volatility will be assessed in relation to the investor's maximum allowable risk. Known formulas may be applied for evaluating this type of risk.

A financial professional 240 may be rated for risk based on previous transactions or based on factors similar to those used to rate investors 200. For example, a financial professional 240 may be evaluated based on his portfolio of assets that he holds or that he actively recommends, by the capital that he recommends prior to investing in his portfolio of assets, or by a risk tolerance that he indicates directly.

Generally, for an investor 200 to go above his automatically assessed risk tolerance for a particular financial professional 240 or investment, he must manually accept the risk difference prior to investing.

### User Interface

FIG. 8 illustrates an exemplary user interface including an implementation of dashboard interface 110 for an investor social network. A navigation bar 1200 is provided for accessing main features of the platform. Through the search feature of the navigation bar 1200, a user may search sectors, funds, stocks, derivatives, or other users, including financial professionals 240 and other investors 200. The navigation bar 1200 also provides access to user settings and personal data, as well as direct links to friends on the network. Through the navigation tools, a user may opt to trade on the platform (or through an affiliated brokerage) or view financial data, such as graphs or videos. A user may also comment on the dashboard interface 110.

A profile summary 1220 is provided to a user, indicating overall performance and acceptable risk level for the user, and a customizable panel 1230 is provided for the user. The user may add sectors, quotes of assets, and other features of interest to him to the panel 1230 and view real time market information, market simulation features, tutorials, and other features.

The focus of the interface is the user wall 1240. This may be the dashboard interface 110 described above, or it may incorporate additional information. In the embodiment shown, the user wall 1240 comprises a sequence of widgets, each of which contain context specific options, and which will be described in more detail below.

The market toolbar 1250 provides access to market tools available in the system. This can include market data, affiliate programs, partners, and other user features.

FIG. 9 shows an operation widget 470 for a transaction. In the example shown, the logo 1300 of the brokerage firm or bank to which the execution order will be sent is shown, the asset to be transacted is identified with a ticker symbol 1310 and logo 1320 of the company, and the current price 1330, and current daily change in the price 1340. Further, the widget 470 shows a summary of the current open book for the asset 1340, and provides easy access to the scheduling and configuration 1350 of a stop order.

Risk levels of assets (volatility), as discussed above, may be identified by colored icons 1360 (green, red, yellow), and icons provide further access to graphical features and technical indicators 1370. The bottom toolbar has features to set sharing options for an order, and provides a button to submit the order.

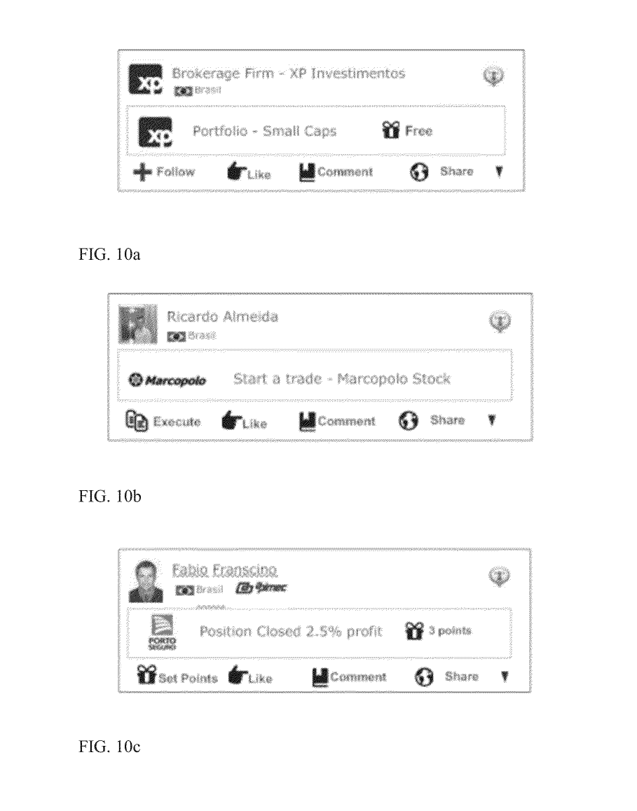

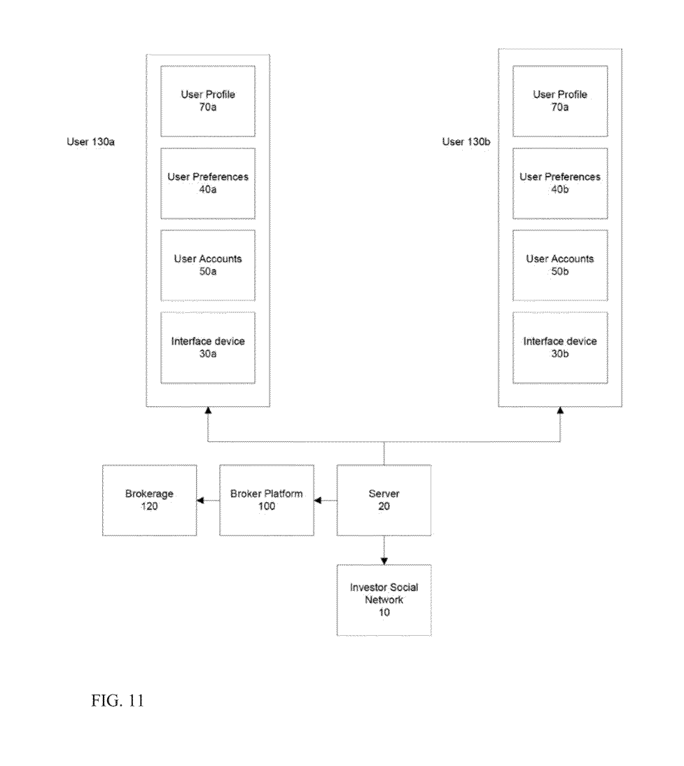

FIG. 10a shows an example of a publication widget, FIG. 10b shows an example of an investor operation widget, and FIG. 10c shows an example of an operation completion widget. In this case, the publication widget provides a recommended portfolio to follow, and provides options to follow the recommended portfolio, like the publication, or comment on it.

Any comments, information, transactions or assets (stocks, funds, derivatives, etc. . . . ), can be shared and viewed by users through the central menu of the main page, shown in FIG. 8. These comments, etc., generally appear in the form of widgets.

Widgets generally include options specific to the widget contents. In the publication widget shown in FIG. 10a, for example, if you select the follow option, if all user options are properly set, all the positions recommended in the portfolio may automatically open, and any changes in the active portfolio will automatically be reflected in the users investments, in order to close all positions and not participate in the portfolio anymore, the user should unfollow this portfolio.

In the investor operation widget shown in FIG. 10b, a transaction has been made by a different investor 200. In this case any user who views the widget can copy the investor's operation by clicking the “execute” option. Some order information may be modified, such as the amount of the asset to be invested and stop points.

The operation completion widget 10c shows a position copied from a financial professional that has been closed for a profit. The sample shows a position closed for the user with 2.5% profit. Upon the closing of the position, some minimal level of credits, identified as points must be awarded (in this case, 3 points). In alternative embodiments, credits must be assigned upon choosing to copy the transaction. The user may therefore assign only that minimum number of credits, or may “set points” to a higher level as a showing of appreciation. The operation may only be copied initially if the 3 credits requested are available to award to the financial professional. However, on closing, the number of credits to be awarded may be increased as a show of appreciation.

It will be noted that each widget shows a colored logo similar to icon 1360 in FIG. 10. These logos indicate risk level for a particular transaction. In some embodiments, only widgets displaying risk levels acceptable to the user are shown in the dashboard interface 110.

FIG. 11 illustrates the basic components of a system for hosting an investor social network 10. As shown in FIG. 1, an investor social network 10 is hosted on a server 20 which connects users 130a-b accessing the investor social network 10 using user interface devices 30a-b. The investor social network 10 is a hub for exchanging information related to investments and financial news, and users 60 accessing the investor social network 10 may share information related to investing, display investments in real time or facilitate investments through a broker platform 100. The broker platform 100 is supported through associations with third party brokerages 120. In some embodiments, viewing of information is limited to a privately registered or approved user group, insuring transparency between group members while maintaining adequate security. In the discussions below, transactions are assumed to be in stocks, but transactions facilitated by the broker platform 100 may be performed in assorted asset classes, such as fixed income securities and other equity and debt securities.

Each user 130 accessing the investor social network 10 has an interface device 30 and is provided with user account 50 defining funds available to the user, user preferences 40, and a user profile 70a. As will be discussed below, the user accounts 50a may be split into subaccounts containing funds available for different purposes, such as investments, or fees associated with investing on the investor social network 10.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” and like terms encompass all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A computer based method for facilitating social network based trading on a computer, the computer based method comprising:
receiving an indication from a first interface device that a first transaction has been selected by a first user in a first security;
providing transaction data defining the first transaction to a second interface device, through a social network, the transaction data including at least one parameter of the first transaction;
receiving an indication from the second interface device that a second user seeks to perform a second transaction copying at least one parameter of the first transaction in the first security;
providing an option to the second user at the second interface device to pay an elective fee to the first user;
publicizing, on the social network, a fee paid for the second transaction from the second user to the first user;
wherein the second user may optionally modify the fee paid to the first user after the second transaction is performed.

2. The computer based method of claim 1 wherein the first user is of a first category of investors and is ranked among members of the first category of investors based on the fee elected by the second user.

3. The computer based method of claim 1 wherein the second transaction has a minimum fee that must be paid by the second user to the first user, and wherein the elective fee is in addition to the minimum fee.

4. The computer based method of claim 3 wherein the minimum fee is waived for the second transaction if the second transaction results in a loss for the second user.

5. The computer based method of claim 3 wherein the minimum fee depends upon an asset transferred in the first transaction.

6. The computer based method of claim 1 wherein the first transaction comprises opening a financial position and closing a financial position and wherein the method further comprises:
receiving the indication that the second user seeks to perform the second transaction after the opening of the financial position before the closing of the financial position, and
providing the option to the second user to pay an elective fee after the closing of the financial position.

7. The computer based method of claim 1 wherein the second user has at least one pre-approved trading rule, and the transaction data provided to the second interface device triggers the indication that the second user seeks to perform the second transaction without any further input from the second user if the first transaction satisfies at least one pre-approved trading rule.

8. The computer based method of claim 7 wherein the second transaction has a minimum fee, and the at least one pre-approved trading rule is satisfied only if the second user has a first account containing sufficient funds to service the minimum fee.

9. The computer based method of claim 7 wherein the second user has a risk threshold and wherein the first transaction has a risk level and wherein the second transaction only occurs if the second user's risk threshold is greater than the risk level of the first transaction.

10. The computer based method of claim 1 further comprising making the transaction data viewable to the second user at the second interface device
wherein the second user has a user profile, and profile data in the user profile determines whether transaction data is viewable to the second user.

11. The computer based method of claim 10 wherein the user profile contains a risk threshold and the first transaction has a risk level, and wherein the transaction data is only made viewable if the risk level is below the risk threshold.

12. The computer based method of claim 10 wherein the user profile contains a risk threshold and the first transaction has a risk level, and wherein the transaction data is only made viewable if the risk level is below the risk threshold or the second user selects an option accepting the additional risk of the first transaction.

13. The computer based method of claim 12 wherein the risk threshold is calculated by the system based on responses to a user questionnaire.

14. The computer based method of claim 12 wherein the risk threshold is defined by a user.

15. The computer based method of claim 12 wherein the risk level of the first transaction is defined based on the transaction data.

16. The computer based method of claim 12 wherein the risk level of the first transaction is defined based on previous transactions of the first user.

17. The computer based method of claim 1 further comprising receiving an indication from the first interface device that the first transaction has been performed prior to providing transaction data related to the first transaction to a second interface device.

18. The computer based method of claim 1 wherein the first transaction is identified by the first user using an algorithmic trading strategy.

19. The computer based method of claim 18 wherein the first user may publish results of an algorithmic trading strategy through the social network, and wherein the results published do not include the transaction data.

20. The computer based method of claim 19 wherein the second user is provided with an option to create a pre-approved trading rule, wherein the transaction data for the first transaction identified by the first user triggers the indication that the second user seeks to perform the second transaction without any further input from the second user.

21. The computer based method of claim 20 wherein the transaction data is not made viewable to the second user.

22. The computer based method of claim 1 wherein the first user is of a first category of investors, and wherein options available to first user are limited by the first category of investors.

23. The computer based method of claim 22 wherein the first user is permitted to identify a transaction in the first security but is not permitted to perform a transaction in the first security.

24. The computer based method of claim 23 wherein, in providing transaction data related to the first transaction, no indication is provided as to whether the transaction identified has been performed.

25. The computer based method of claim 1 wherein fees are paid from a stored value account, and wherein funds may be added to the stored value account by the second user, or may be awarded by a manager or sponsor of the social network.

26. The computer based method of claim 25 wherein funds are awarded to the second user based on levels of activity within the social network or participation in promotions.

27. The computer based method of claim 1 further comprising directing the indication that the second user seeks to perform the second transaction to a brokerage through the social network.

28. A computer system to facilitate a social network based financial transactions, the computer system comprising:
a first interface device;
a second interface device;
a computer for interacting via a computer network with the first and second interface devices;
wherein the computer is configured to:
receive an indication from the first interface device that a first transaction has been selected by a first user in a first security;
provide transaction data defining the first transaction to the second interface device, the transaction data including at least one parameter of the first transaction;
receive an indication from the second interface device that a second user seeks to perform a second transaction copying at least one parameter of the first transaction in the first security;
provide an option to the second user at the second interface device to pay an elective fee to the first user;
publicize, on a social network, a fee paid for the second transaction from the second user to the first user;
wherein the second user may optionally modify the fee paid to the first user after the second transaction is performed.

29. The computer system of claim 28 wherein the first user is of a first category of investors and is ranked among members of the first category of investors based on the fee elected by the second user.

30. The computer system of claim 28 wherein the second transaction has a minimum fee that must be paid by the second user to the first user, and wherein the elective fee is in addition to the minimum fee.

31. The computer system of claim 30 wherein the minimum fee is waived for the second transaction if the second transaction results in a loss for the second user.

32. The computer system of claim 30 wherein the minimum fee depends upon an asset transferred in the first transaction.

33. The computer system of claim 28 wherein the first transaction comprises opening a financial position and closing a financial position and wherein the computer:
receives the indication that the second user seeks to perform the second transaction after the opening of the financial position before the closing of the financial position, and
provides the option to the second user to pay an elective fee after the closing of the financial position.

34. The computer system of claim 28 wherein the second user has at least one pre-approved trading rule, and the transaction data provided to the second interface device triggers the indication that the second user seeks to perform the second transaction without any further input from the second user if the first transaction satisfies at least one pre-approved trading rule.

35. The computer system of claim 34 wherein the second transaction has a minimum fee, and the at least one pre-approved trading rule is satisfied only if the second user has a first account containing sufficient funds to service the minimum fee.

36. The computer system of claim 34 wherein the second user has a risk threshold and wherein the first transaction has a risk level and wherein the second transaction only occurs if the second user's risk threshold is greater than the risk level of the first transaction.

37. The computer system of claim 28 wherein the computer makes the transaction data viewable to the second user at the second interface device
wherein the second user has a user profile, and profile data in the user profile determines whether transaction data is viewable to the second user.

38. The computer system of claim 37 wherein the user profile contains a risk threshold and the first transaction has a risk level, and wherein the transaction data is only made viewable if the risk level is below the risk threshold.

39. The computer system of claim 37 wherein the user profile contains a risk threshold and the first transaction has a risk level, and wherein the transaction data is only made viewable if the risk level is below the risk threshold or the second user selects an option accepting the additional risk of the first transaction.

40. The computer system of claim 39 wherein the risk threshold is calculated by the system based on responses to a user questionnaire.

41. The computer system of claim 39 wherein the risk threshold is defined by a user.

42. The computer system of claim 39 wherein the risk level of the first transaction is defined based on the transaction data.

43. The computer system of claim 39 wherein the risk level of the first transaction is defined based on previous transactions of the first user.

44. The computer system of claim 27 wherein the computer is further configured to receive an indication from the first interface device that the first transaction has been performed prior to providing transaction data related to the first transaction to a second interface device.

45. The computer system of claim 27 wherein the first transaction is identified by the first user using an algorithmic trading strategy.

46. The computer system of claim 45 wherein the first user may publish results of an algorithmic trading strategy through the social network, and wherein the results published do not include the transaction data.

47. The computer system of claim 46 wherein the computer is further configured to provide the second user with an option to create a pre-approved trading rule, wherein the transaction data for the first transaction identified by the first user triggers the indication that the second user seeks to perform the second transaction without any further input from the second user.

48. The computer system of claim 47 wherein the transaction data is not made viewable to the second user.

49. The computer system of claim 27 wherein the first user is of a first category of investors, and wherein user options available to first user are limited by the first category of investors.

50. The computer system of claim 49 wherein the first user is permitted to identify a transaction in the first security but is not permitted to perform a transaction in the first security.

51. The computer system of claim 50 wherein, in providing transaction data related to the first transaction, no indication is provided as to whether the transaction identified has been performed.

52. The computer system of claim 27 wherein fees are paid from a stored value account, and wherein funds may be added to the stored value account by the second user, or may be awarded by a manager or sponsor of the social network.

53. The computer system of claim 52 wherein funds are awarded to the second user based on levels of activity within the social network or participation in promotions.

54. The computer system of claim 27, the computer further configured to direct the indication that the second user seeks to perform the second transaction to a brokerage through the social network.
